(19) United States
(12) Patent Application Publication
(10) Pub. No.: US 2024/0404775 A1
(43) Pub. Date: Dec. 5, 2024

(54) ELECTRONIC COMPONENT

(71) Applicant: OMRON Corporation, KYOTO (JP)

(72) Inventors: Toyohiro IMAIZUMI, Kyoto-shi (JP); Osamu OTANI, Kyoto-shi (JP)

(73) Assignee: OMRON Corporation, KYOTO (JP)

(21) Appl. No.: 18/631,080

(22) Filed: Apr. 10, 2024

(30) Foreign Application Priority Data
May 31, 2023 (JP) 2023-090401

(51) Int. Cl. H01H 45/02; H01H 9/04; H01R 13/527

(52) U.S. Cl. CPC H01H 45/02; H01H 9/04; H01H 2223/044; H01R 13/527

(57) ABSTRACT

A relay includes a base, a card, and a case molded from a flame-retardant resin composition containing a resin material, a brominated flame retardant, and an inorganic flame-retardant aid. The inorganic flame-retardant aid contains at least one element selected from Group IV elements.

### CROSS-REFERENCE TO RELATED APPLICATION

This application claims the priority benefit of Japan application serial no. 2023-090401, filed on May 31, 2023. The entirety of the above-mentioned patent application is hereby incorporated by reference herein and made a part of this specification.

### BACKGROUND

### Technical Field

The disclosure relates to an electronic component.

### Related Art

For example, Patent Literature 1 (Japanese Patent Application Laid-Open No. 2020-105433) describes a polyester resin composition containing 1 to 80 parts by weight of a predetermined brominated flame retardant, 10 to 100 parts by weight of glass fiber, and 1 to 30 parts by weight of an antimony-based flame-retardant aid with respect to 100 parts by weight of polyester resin.

Further, for example, Patent Literature 2 (Japanese Patent Re-publication No. 2007/007663) describes a flame-retardant resin composition containing a base resin, a halogen-based flame retardant, at least one organic/inorganic acid salt selected from organic phosphinates and oxoacid salts of basic nitrogen-containing compounds, and an electrical property improver, and the electrical property improver contains at least one selected from olefinic resins, fluororesins, and Group 4 metal compounds of the periodic table. Patent Literature 2 also describes that the flame-retardant resin composition contains a flame-retardant aid such as an antimony-containing compound (antimony trioxide).

Antimony trioxide contained in the resin compositions disclosed in Patent Literatures 1 and 2 is reported to be weakly irritating to skin and mucous membranes, and its carcinogenicity is also being discussed.

More specifically, since 2013, the Rohs Directive has started discussions on regulation of antimony trioxide. A re-evaluation was proposed in December 2019, and the direction of regulation was planned to be indicated once in 2020, but based on interviews with relevant parties, it is expected that the current policy will not be to regulate the use of antimony trioxide. In addition, the International Agency for Research on Cancer (IARC) defines the carcinogenicity of antimony trioxide as “possibly carcinogenic to humans (2B).” Currently, additional tests are being conducted, and if the results raise the level to “probably carcinogenic to humans (2A),” it may become subject to REACH regulations.

In view of the above-mentioned circumstances, antimony trioxide regulations in the future are anticipated, and electric components using flame-retardant aids that are highly safe against environmental pollution such as air pollution and water pollution are useful. However, it is difficult to achieve sufficient flame retardancy in molded bodies of resin compositions using flame-retardant aids other than antimony trioxide.

Therefore, there is a demand for a novel electronic component that is safer against environmental pollution such as air pollution and water pollution than the electronic components disclosed in Patent Literatures 1 and 2, and that has high flame retardancy.

### SUMMARY

An electronic component according to an embodiment of the disclosure includes a molded body molded from a flame-retardant resin composition containing a resin material, a brominated flame retardant, and an inorganic flame-retardant aid. The inorganic flame-retardant aid contains at least one element selected from Group IV elements.

With the above configuration, it is possible to provide a novel electronic component that is highly safe against environmental pollution such as air pollution and water pollution, and has high flame retardancy.

Further, the electronic component according to an embodiment of the disclosure in the above embodiment may further include an electrical contact, or the electrical contact and a coil, and may enclose the electrical contact and the coil or may be in contact with the electrical contact or the coil.

With the above configuration, it is possible to increase the safety of the electronic component including the electrical contact or the electrical contact and the coil against environmental pollution such as air pollution and water pollution, and to impart high flame retardancy to the electronic component.

Further, in the electronic component according to an embodiment of the disclosure in any of the above embodiments, the molded body may be at least one molded body selected from a base, a case, a card, a spool, and a housing.

With the molded body having the above configuration, it is possible to provide an electronic component with high flame retardancy.

Further, the electronic component according to an embodiment of the disclosure in any of the above embodiments may be a relay, a switch, or a connector.

With the above configuration, it is possible to provide an electronic component that is highly safe against environmental pollution such as air pollution and water pollution, and has high flame retardancy.

Further, in the electronic component according to an embodiment of the disclosure in any of the above embodiments, the resin material may be polyester-based resin.

With the above configuration, it is possible to provide an electronic component having good moldability of thin parts, and furthermore, to provide an electronic component having high flame retardancy and high mechanical strength.

Further, in the electronic component according to an embodiment of the disclosure in any of the above embodiments, it is preferable that the molded body has a thickness of less than 2.0 mm at a thinnest part.

An electronic component according to an embodiment of the disclosure with the above configuration is a miniaturized electronic component and has high flame retardancy.

Further, in the electronic component according to an embodiment of the disclosure in any of the above embodiments, it is preferable that the molded body has a thickness of 0.5 mm or less at a thinnest part.

An electronic component according to an embodiment of the disclosure with the above configuration is a further miniaturized electronic component and has high flame retardancy.

According to an embodiment of the disclosure, it is possible to provide a novel electronic component that is highly safe against environmental pollution such as air pollution and water pollution, and has high flame retardancy.

### BRIEF DESCRIPTION OF DRAWINGS

FIG. 1 is a schematic diagram illustrating a relay 10, which is an electronic component according to an embodiment.

FIG. 2 is a diagram illustrating a cross section of a card 31 and illustrating a thickness a1 of a minimum thickness part of a molded body that configures the electronic component.

FIG. 3 is a schematic diagram for a flame retardancy evaluation apparatus in accordance with the UL94 flammability test standard.

### DESCRIPTION OF EMBODIMENTS

An embodiment of the disclosure provides a novel electronic component that is highly safe against environmental pollution such as air pollution and water pollution and has high flame retardancy, and provides a flame-retardant resin composition for producing the electronic component.

Hereinafter, an embodiment (hereinafter also referred to as “this embodiment”) according to one aspect of the disclosure will be described in detail.

In this specification, a numerical range indicated using “X to Y” indicates a range including X and Y as the minimum and maximum values, respectively.

### § 1 Application Example

### <Electronic Component>

An electronic component according to an embodiment of the disclosure includes a molded body molded from a flame-retardant resin composition containing a resin material, a brominated flame retardant, and an inorganic flame-retardant aid. The inorganic flame-retardant aid contains at least one element selected from Group IV elements.

For convenience of illustration, in the following, the “inorganic flame-retardant aid” contained in the flame-retardant resin composition of the molded body included in the electronic component according to the embodiment of the disclosure will be referred to as a “predetermined inorganic flame-retardant aid”.

An electronic component according to an embodiment of the disclosure may be an electronic component forming a part of an electrical circuit, and may be, for example, an electronic component having electrical contacts for turning on/off an electrical circuit, switching an electrical circuit, or connecting to an electrical circuit. The electronic component may include at least one electrical contact, and may include a coil and core that form a magnetic circuit.

The molded body included in the electronic component may be a member that is heated by each member that is energized via an external circuit, and may be a molded body that requires insulation.

Since the electronic component includes a molded body of a flame-retardant resin composition containing a predetermined inorganic flame-retardant aid, it may have flame retardancy equivalent to that of an electronic component including a molded body containing diantimony trioxide (Sb₂O₃, hereinafter also referred to as antimony trioxide) as the flame-retardant aid.

Therefore, the electronic component according to the embodiment has flame retardancy comparable to that of an electronic component and a flame-retardant resin composition using antimony trioxide, and from the viewpoint of environmental pollution such as air pollution and water pollution as well, it may be provided as an electronic component with high safety.

The electronic component according to the embodiment may include, for example, a relay, a switch, a connector, and the like. Further, the electronic component according to the embodiment may be, for example, a sensor or the like.

### § 2 Configuration Example

### [1] Relay

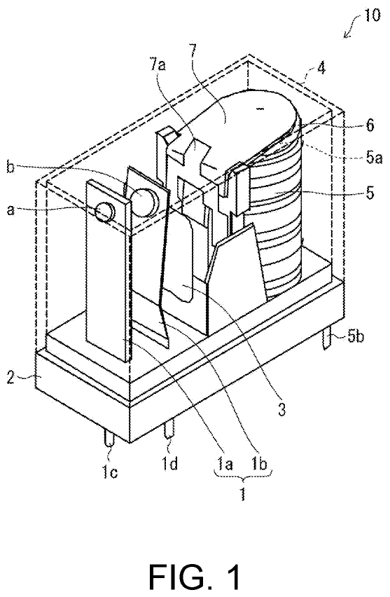

FIG. 1 is a schematic diagram illustrating a relay 10, which is an electronic component according to an embodiment. The relay 10 includes a contact (electrical contact) 1, a base 2, a card 3, a case 4, a coil 5, a spool 6, and an iron piece 7. In FIG. 1, the base 2 and the card 3 are in contact with the contact 1, and the case 4 encloses the contact 1.

The contact 1 includes a fixed piece 1a and a movable piece 1b. The fixed piece la includes a fixed contact a and a fixed piece terminal 1c, and the movable piece 1b includes a movable contact b and a movable piece terminal 1d.

The fixed piece 1a and the movable piece 1b are fixed to the base 2 to face each other. The movable piece 1b is biased so that the movable contact b is separated from the fixed contact a. Both the fixed piece terminal 1c and the movable piece terminal 1d are terminals connected to an external circuit of the relay 10.

The movable piece 1b moves together with the card 3 when the card 3 moves toward the movable piece 1b, and brings the movable contact b into contact with the fixed contact a. In this way, the fixed piece terminal 1c and the movable piece terminal 1d are energized. This energization heats the contact 1, heats the base 2, the card 3, and the case 4 through the fixed piece 1a and the movable piece 1b, and the spool 6 may also be further heated. Therefore, the base 2, the card 3, the case 4, and even the spool 6 require high flame retardancy.

The base 2 is a molded body for fixing the fixed piece 1a, the movable piece 1b, the coil 5, the iron core 5a, and the iron piece 7 respectively at positions where insulation distance may be secured between them, and it may be a molded body molded from the flame-retardant resin composition containing the predetermined inorganic flame-retardant aid.

The card 3 transmits a force applied from the iron piece 7 to the movable piece 1b. The card 3 is a molded body for moving the movable contact b of the movable piece 1b toward the fixed contact a of the fixed piece 1a while securing the insulation distance between the movable piece 1b and the coil 5, and may be a molded body molded from the flame-retardant resin composition containing the predetermined inorganic flame-retardant aid. When the coil 5 is energized, one end of the iron piece 7 is attracted toward the spool 6 by the magnetic force generated in the iron core 5a disposed inside the coil 5. Along with this, a force is applied to the card 3 by moving the other end of the iron piece 7.

The case 4 is a molded body for dust protection for the contact 1, securing of the insulation distance between the contact 1 and the coil 5, and protection for the contact 1 and the coil 5, and may be a molded body molded from the flame-retardant resin composition containing the predetermined inorganic flame-retardant aid.

The relay 10 includes the coil 5, an iron core 5a, and a coil terminal 5b. The relay 10 makes the iron core 5a an electromagnet in a magnetic circuit by the magnetic flux of the coil 5 generated when the coil terminal 5b is energized. The coil 5, also referred to as a wire terminal, may generate heat when continuously energized. The heat may also heat the base 2, the card 3, the case 4, and the spool 6.

The spool 6 is a molded body for securing the insulation distance between the coil 5 and the iron piece 7, and may be a molded body molded from the flame-retardant resin composition containing the predetermined inorganic flame-retardant aid. The spool 6 may be a molded body for fixing the coil 5 to the base 2 while maintaining the insulation distance between the coil 5 and the iron piece 7.

When the energization to the coil 5 is cut off by an external circuit, the iron piece 7 is biased away from the spool 6 by a hinge spring 7a. At this time, the pressing force on the card 3 by the iron piece 7 is released, and the movable contact b is separated from the fixed contact a accordingly. Thereby, the energization to the contact 1 is cut off.

In addition, the relay according to the embodiment is not limited to the relay 10 illustrated in FIG. 1, and may include other metal members such as yokes. Moreover, the relay according to the embodiment may include a molded body molded from the flame-retardant resin composition containing the predetermined inorganic flame-retardant aid, in addition to the base, the card, the case, and the spool.

The molded body such as the base, the card, the case, and the spool included in the relay may be formed with protrusions and recesses for defining the disposition of the above-described members such as the contacts, the coils, the iron cores, and the iron pieces; protrusions and recesses formed as guides for fitting the base and the case together in a predetermined disposition; protrusions and recesses for guiding the movement of the card within the case; and the like. The protrusions and recesses of the molded body may be protrusions and recesses such as ribs, or protrusions and recesses derived from the shape of the design given to the relay. These protrusions and recesses define a thinnest part and a thickness thereof of each molded body. Further, the protrusions and recesses of the molded body may be provided as protrusions and recesses that define a hole such as a through hole through which an electrical contact or the like is inserted.

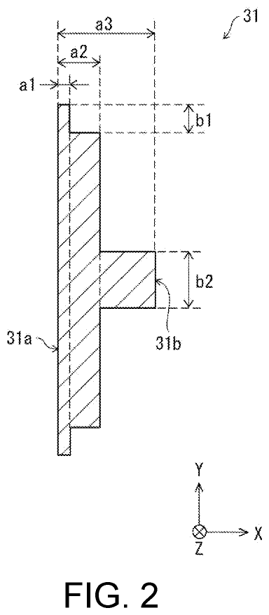

FIG. 2 is a diagram illustrating a cross section of a card 31 and illustrating the definition of a thickness a1 of a minimum thickness part of the molded body that configures the electronic component.

The card 31 shown in FIG. 2 is a card in which an iron piece (not shown) is in contact with a flat part 31a and a movable contact (not shown) is in contact with a protrusion 31b, and the card 31 moves along an X direction shown in FIG. 2 according to the movements of the iron piece and the movable contact. The X direction in FIG. 2 is also the thickness direction of the card 31. The thickness direction may also be a normal direction to a plane serving as a reference of the molded body.

As shown in FIG. 2, the card 31 is formed with protrusions and recesses with thicknesses a1, a2, and a3 along the thickness direction; and along a Y direction (that is, the longitudinal direction), the thicknesses of these protrusions and recesses are defined as thicknesses b1 and b2. In the card 31, the thickness increases in the order of a1, b1, a2, b2, and a3, with a1 being the thinnest and a3 being the thickest. Therefore, in the card 31, the thickness a1 of the thinnest part corresponds to the thickness of the minimum thickness part. Although illustration is omitted for convenience, if there is a part thinner than a1 in a Z direction shown in FIG. 2 (that is, in the lateral direction of the card 31), the part thinner than a1 becomes the minimum thickness part.

If the molded body is not a card but a molded body with multiple surfaces such as a case and housing, the thinnest part of all the surfaces of the molded body is defined as the minimum thickness part. The minimum thickness part is a part of the molded body having the thinnest thickness not only in the thickness direction but also in the longitudinal and lateral directions.

The thickness of the minimum thickness part in the molded body is preferably less than 2.0 mm, preferably less than 0.8 mm, and more preferably 0.5 mm or less. In addition, since the thickness of the minimum thickness part is 0.3 mm or more, it is possible to maintain the mechanical strength of each molded body in the electronic component, and a level of flame retardancy comparable to that of an electronic component using antimony trioxide as the flame-retardant aid may be achieved by adopting molded bodies containing the predetermined inorganic flame-retardant aid.

The thickness a3 of the molded body exemplified by the card 31 is the thickness of the molded body other than the minimum thickness part, and may be designed in a range thicker than the thickness a1. For example, by setting the thickness a3 of the molded body other than the minimum thickness part to 2.0 mm or more, it is possible to provide an electronic component having high mechanical strength while having high flame retardancy. Further, the thickness a3 of the molded body other than the minimum thickness part may be appropriately designed according to the type of molded body.

The thickness a2 of the molded body exemplified by the card 31 may be greater than or equal to the thickness a1 and less than or equal to the thickness a3. Moreover, the thicknesses b1 and b2 of the molded body in the longitudinal direction may be appropriately designed within a range thicker than the thickness a1 of the minimum thickness part of the molded body. However, it should be understood that if the parts corresponding to the thicknesses b1 and b2 in the molded body are the thinnest, the thicknesses b1 and b2 of the parts should be designed as the minimum thickness parts.

Relays that require high flame retardancy include, for example, relays that are required to turn on, turn off, or switch external circuits under high current and/or high voltage conditions, and relays that are further required to be miniaturized. More specific examples of the relay according to the embodiment includes a power relay, a micro relay, a surface mount relay, and the like.

### [2] Switch

The electronic component according to the embodiment is not limited to the relay described above. The electronic component according to the embodiment includes, for example, a switch.

The switch is a switch that configures a part of an electrical circuit, and is an electronic component for switching the electrical circuit. The switch includes an actuator part, a snap action mechanism, an electrical contact, and a housing. The housing of the switch includes a housing that protects the snap action mechanism and the electrical contact while maintaining the insulation distance therebetween. In the switch, the housing is also referred to as a cover.

The switch transmits a force or a movement outside the housing to the snap action mechanism disposed inside the housing by the actuator part. The types of the actuator part provided in the switch include push-button types and lever types. The types of the actuator part may be selected as appropriate according to the use of the switch.

The switch includes a conductive spring as the snap action mechanism, and a movable contact is provided at the end of the conductive spring. Further, the electrical contact included in the switch may be configured by two fixed contacts facing each other inside the housing and a movable contact provided on a conductive spring between the two fixed contacts. The movable contact provided at the end of the snap action mechanism may switch which of the two fixed contacts is to be contacted, depending on the movement transmitted from the actuator part. Herein, the snap action mechanism and the two fixed contacts each have external terminals that are connected to the outside of the housing. The movable contact provided in the snap action mechanism contacts one of the two fixed contacts inside the housing to energize it, and at this time cuts off the energization to other fixed contact. This allows the switch to switch external electrical circuits. The switch generates heat by energizing the contacts in the housing. Therefore, the housing of the switch is required to be highly flame-retardant.

Therefore, in the switch according to the embodiment, the housing may be molded from the flame-retardant resin composition containing the predetermined inorganic flame-retardant aid.

As in the case of the relay, the molded body such as the housing included in the switch is formed with protrusions and recesses and the like for defining the disposition of members such as the actuator part, the snap action mechanism, and the electrical contact. Herein, the housing of the switch according to the embodiment may be designed with the thickness of the minimum thickness part, as in the case of the card 31 described above. In addition, thicknesses other than the thickness of the minimum thickness part of the housing may be designed as appropriate. The switch according to the embodiment achieves miniaturization of the switch itself by designing the thickness of the minimum thickness part of the housing, and may achieve high flame retardancy comparable to that of a switch including a molded body containing antimony trioxide.

The housing included in the switch according to the embodiment may be formed by combining multiple parts into one housing. Moreover, the switch may include a molded body molded from the flame-retardant resin composition containing the predetermined inorganic flame-retardant aid in addition to the housing.

Specific examples of the switch according to the embodiment include, for example, a switch that is required to switch under high current and/or high voltage conditions, and furthermore, a switch that is required to be miniaturized. More specifically, the switch according to the embodiment includes a switch such as a micro switch, an ultra-small basic switch, and a seal-type ultra-small basic switch.

### [3] Connector

The electronic component according to the embodiment is not limited to the relay and the switch described above. The electronic component according to the embodiment includes, for example, a connector.

The connector may be an electronic component that provides a connection between two electrical circuits or a connection between an electrical circuit and a power source. The connector includes a contact (also called a pin or an electrode) for connection with an electrical circuit, and a housing for protecting and fixing the contact. Herein, the electrical circuit may be a printed circuit board or a flexible circuit board. The connector generates heat when an electrical signal or an electrical current flows through the contact that connects each electrical circuit. Therefore, the housing of the connector is required to be highly flame-retardant.

Therefore, in the connector according to an embodiment, the housing may be molded from the flame-retardant resin composition containing the predetermined inorganic flame-retardant aid.

The shape of the connector may be a plug or jack attached to a cable, or a receptacle attached to an electrical circuit such as a board. Further, the connector may be of the pin-insert type or the socket-insert type. The connector may be, for example, an audio/video connector, a communication connector, and a power connector.

The disposition of the contact of the connector is determined according to the standard. Accordingly, the housing of the connector is molded with its shape (that is, protrusions and recesses) conforming to the disposition of the contact. Herein, the housing of the connector according to the embodiment may be designed with the thickness of the minimum thickness part, as in the case of the card 31 described above. Further, the thickness of the connector other than the thickness of the minimum thickness part of the housing may be designed in the same way as the card 31. The connector according to the embodiment achieves miniaturization of the connector itself by designing the thickness of the minimum thickness part of the housing (molded body), and may achieve high flame retardancy by the molded body formed from the flame-retardant resin composition containing the predetermined inorganic flame-retardant aid.

The housing included in the connector according to the embodiment may be formed by combining multiple parts to form one housing, and may include a molded body molded from the flame-retardant resin composition containing the predetermined inorganic flame-retardant aid in addition to the housing. For example, the connector according to the embodiment may include a locking mechanism (lock lever) for locking the connector to the electrical circuit after the contacts are connected, and the locking mechanism may be a molded body formed from the flame-retardant resin composition containing the predetermined inorganic flame-retardant aid.

The connector according to the embodiment includes, for example, a flexible flat cable (FFC) connector, a half-pitch connector, and the like. Further, the connector may be, for example, a connector conforming to standards such as DIN and MIL.

### [4] Flame-Retardant Resin Composition

The electronic component according to the embodiment includes a molded body molded from a flame-retardant resin composition containing a predetermined inorganic flame-retardant aid. The flame-retardant resin composition contains a resin material, a brominated flame retardant, and a predetermined inorganic flame-retardant aid, and may contain other materials besides these.

### [4-1] Inorganic Flame-Retardant Aid

Antimony trioxide is currently used as a flame-retardant aid, but it may be subject to regulation in the future. The inventors of the disclosure use a molded body of a flame-retardant resin composition containing a predetermined inorganic flame-retardant aid as the flame-retardant aid for an electronic component that is thin; in other words, the thickness of the molded body is thin. In this way, it is possible to obtain flame retardancy equivalent to that of an electronic component using a molded body of a flame-retardant resin composition containing antimony trioxide as the flame-retardant aid.

A resin molding material containing antimony trioxide generates antimony halide by heat during combustion and halogen derived from a halogen-based flame retardant, and the antimony halide is vaporized by heat. Antimony halide is highly stable against heat, suppresses an increase in active gas concentration in the vicinity of the resin molding material, and suppresses supply of oxygen to the burning resin molding material. This imparts flame retardancy to the resin molding material. Herein, the active gas may refer to a combustible organic substance generated by thermally decomposing a resin molding material, that is, a decomposed gas.

For example, diantimony trioxide (Sb₂O₃, hereinafter also simply referred to as antimony trioxide) generates antimony bromide according to the reaction formula shown below.

⅙Sb₂O₃+HBr→⅓SbBr₃+H₂O [Chemical Formula 1]

According to the Labor Standards Act, antimony trioxide is a chemical substance that causes illness that should be compensated for occupational medical treatment. According to the Industrial Safety and Health Act, it is designated as a substance subject to labeling and notification, and in the Poisonous and Deleterious Substances Control Law, it is designated as a deleterious substance (Poisonous and Deleterious Substances Designation Ordinance, Article 2). Antimony trioxide is designated as a hazardous air pollutant (Cabinet Order, Article 2-1 No. 7) under the Air Pollution Control Act), and it is also designated as a designated substance (Cabinet Order, Article 3-3 No. 47) in the Water Pollution Control Act. In addition, as determined by GHS, antimony trioxide is classified as Category 1B and “possibly carcinogenic.”

In contrast, the predetermined inorganic flame-retardant aid to be described below does not fall under the Industrial Safety and Health Act, Poisonous and Deleterious Substances Control Act, Air Pollution Control Act, and Water Pollution Control Act, and falls under Category 1 in terms of GHS hazards to health. Therefore, it is an inorganic flame-retardant aid which is promising as a substitute for antimony trioxide in terms of work environment and safety against environmental pollution such as air and water quality.

The predetermined inorganic flame-retardant aid contains at least one element selected from Group IV elements as an inorganic element. The Group IV element contained in the predetermined inorganic flame-retardant aid is preferably selected from a group consisting of titanium (Ti), zirconium (Zr), and hafnium (Hf), and is more preferably selected from a group consisting of zirconium (Zr) and hafnium (Hf). All of these Group IV elements may be obtained as tetravalent oxides, and all of them share a common characteristic that they produce tetravalent halides.

Examples of the predetermined inorganic flame-retardant aid include inorganic oxides that are oxides of inorganic elements selected from titanium (Ti), zirconium (Zr), and hafnium (Hf), which are Group IV elements. The inorganic oxides may include, for example, titanium oxide (TiO₂), zirconium oxide (ZrO₂), hafnium oxide (HfO₂), etc., and may be inorganic hydroxides that are precursors of these inorganic oxides, or gels of inorganic hydroxides obtained by a sol-gel method or the like. Among these, it is more preferable that the predetermined inorganic flame-retardant aid is zirconium oxide (ZrO₂) from the viewpoint of imparting higher flame retardancy to the electronic component. The inorganic flame-retardant aid generates titanium bromide (TiBr₄), zirconium bromide (ZrBr₄), or hafnium bromide (HfBr₄) by burning together with the brominated flame retardant.

That is, the predetermined inorganic flame-retardant aid is obtained as an inorganic powder, and the inorganic powder may be an aggregate of porous particles. The inorganic powder may have an average particle diameter (D50) of, for example, 0.1 μm to 100 μm, and more preferably, 1 μm to 50 μm. In the range of 0.1 μm to 100 μm, the smaller the average particle diameter (D50), the higher flame retardancy can be provided to the molded body of the flame-retardant resin composition.

The content of the predetermined inorganic flame-retardant aid contained in the molded body of the flame-retardant resin composition may be adjusted by adjusting the ratio with the content of the brominated flame retardant described later. For example, the content of the brominated flame retardant: the content of the predetermined inorganic flame-retardant aid is preferably within the range of 8:1 to 1:1, and more preferably, within the range of 4:1 to 2:1. The content of the brominated flame retardant: the content of the predetermined inorganic flame-retardant aid in the flame-retardant resin composition is within the range of 8:1 to 1:1, and by increasing the content of the predetermined inorganic flame-retardant aid, the flame retardancy of the brominated flame retardant may be sufficiently exhibited. Further, the content of the brominated flame retardant: the content of the predetermined inorganic flame-retardant aid in the flame-retardant resin composition is within the range of 8:1 to 1:1, and by decreasing the content of the predetermined inorganic flame-retardant aid, the moldability of the molded body including the flame-retardant resin composition may be enhanced. Therefore, while using the predetermined inorganic flame-retardant aid, it is possible to obtain flame retardancy comparable to that of an electronic component having a molded body using antimony trioxide as the flame-retardant aid. In addition, by containing the predetermined inorganic flame-retardant aid as the flame-retardant aid in the resin material, even if antimony trioxide is subject to regulation under the Rohs Directive and REACH regulations, an electronic component with high flame retardancy may be provided.

### [4-2] Brominated Flame Retardant

The brominated flame retardant burns together with the molded body of the flame-retardant resin composition, and serves as a source of bromine to the predetermined inorganic flame-retardant aid. The brominated flame retardant is preferably a high-molecular-weight flame retardant such as TBA epoxy oligomer, TBA polycarbonate oligomer, brominated polystyrene, bis (tetrabromophthalimide) ethane, and the like. In the disclosure, TBA is an abbreviation for tetrabromobisphenol A. Further, the brominated flame retardant may also include, for example, tetrabromobisphenol A, tetrabromobenzene, hexabromobenzene, tribromofer, hexabromocyclodecane, and the like. It is preferable to use a high-molecular-weight brominated flame retardant because it may prevent bleeding onto the molded body surface and is not a prohibited substance.

The content of the brominated flame retardant contained in the molded body of the flame-retardant resin composition is not limited, but is preferably 5 to 50 parts by weight, preferably 5 to 20 parts by weight, and more preferably 8 to 18 parts by weight, with respect to 100 parts by mass of the resin material. By using 5 parts by mass or more of the brominated flame retardant with respect to 100 parts by mass of the resin material, sufficient bromine may be supplied to the predetermined inorganic flame-retardant aid, thereby enhancing the flame retardancy of the electronic component. In addition, by using 50 parts by mass or less of the brominated flame retardant with respect to 100 parts by mass of the resin material, the fluidity of the flame-retardant resin composition during molding and the mechanical strength of the molded body molded from the flame-retardant resin composition may be enhanced. Therefore, the electronic component may be suitably miniaturized.

### [4-3] Resin Material

Examples of the resin material include engineering plastics such as nylon 6, nylon 66, polyacetal, polycarbonate, modified polyphenylene ether, polyethylene terephthalate, polybutylene terephthalate, PC-ABS (polymer alloy of polycarbonate/acrylonitrile butadiene styrene); general-purpose plastics such as polyvinyl chloride, polyethylene, polypropylene, polystyrene, ABS, and polymethyl methacrylate; thermoplastics such as phenolic resins, urea resins, melamine resins, epoxy resins, unsaturated polyesters, silicone resins, and polyurethanes; super engineering plastics such as polysulfone, polyethersulfone, polyarylate, polyamidoimide, polyetherimide, liquid crystal polymer, polytetrafluoroethylene, polychlorotrifluoroethylene, polyvinylidene fluoride; and the like Among these resin materials, polyester-based resins such as polyethylene terephthalate and polybutylene terephthalate are preferred as engineering plastics from the viewpoint of ease of molding, mechanical strength of the molded body, and manufacturing cost.

The polyester-based resins as engineering plastics include, for example, a dicarboxylic acid component and a diol component; examples of dicarboxylic acids include aromatic dicarboxylic acids such as terephthalic acid, isophthalic acid, and naphthalenedicarboxylic acid, and aliphatic dicarboxylic acids such as adipic acid and sebacic acid; and examples of diols include aliphatic glycols such as ethylene glycol, 1,4-butanediol and polyoxymethylene glycol.

### [4-4] Other Components

The flame-retardant resin composition may contain other components such as a reinforcing agent. Examples of the reinforcing agent include glass fiber, wollastonite, zonolite, sepiolite, mica, potassium titanate whiskers, layered silicates, and organized bentonite. The flame-retardant resin composition preferably contains 1 to 50 parts by mass of the reinforcing agent with respect to 100 parts by mass of the resin material. By containing 1 part by mass or more of the reinforcing agent with respect to 100 parts by mass of the resin material, it is possible to increase the mechanical strength derived from the resin composition even in a small electronic component. Further, by containing 50 parts by mass or less of the reinforcing agent with respect to 100 parts by mass of the resin material, it is possible to maintain the fluidity of the flame-retardant resin composition when molding the molded body.

The flame-retardant resin composition may contain, as other components, additives such as antioxidants, hydrolysis inhibitors, lubricants, dispersing and wetting agents, and silane coupling agents.

The flame-retardant resin composition is prepared by preliminarily mixing the resin material, the brominated flame retardant, and the predetermined inorganic flame-retardant aid with a known mixer such as a Henschel mixer, and then melt-kneading the mixture with a known melt-kneading device such as a twin-screw extruder, and then pelletizing. The heating temperature and kneading time during melt-kneading may be appropriately designed according to the type of the resin material contained in the flame-retardant resin composition, and the blending amount of the brominated flame retardant, the predetermined inorganic flame-retardant aid, and the like.

Further, the method for molding a molded body from the flame-retardant resin composition includes known methods such as extrusion molding and press molding, and may be appropriately designed according to the type of the flame-retardant resin composition and the size of the molded body to be produced.

### SUMMARY

An electronic component according to an aspect 1 of the disclosure includes a molded body molded from a flame-retardant resin composition containing a resin material, a brominated flame retardant, and an inorganic flame-retardant aid. The inorganic flame-retardant aid contains at least one element selected from Group IV elements.

The electronic component of an aspect 2 of the disclosure in accordance with the aspect 1 may further include an electrical contact, or the electrical contact and a coil. The molded body may enclose the electrical contact and the coil or may be in contact with the electrical contact or the coil.

In the electronic component of an aspect 3 of the disclosure in accordance with the aspect 1 or 2, the molded body may be at least one molded body selected from a base, a case, a card, a spool, and a housing.

In the electronic component of an aspect 4 of the disclosure in accordance with any one of the aspects 1 to 3, the electronic component may be a relay, a switch, or a connector.

In the electronic component of an aspect 5 of the disclosure in accordance with any one of the aspects 1 to 4, the resin material may be polyester-based resin.

In the electronic component of an aspect 6 of the disclosure in accordance with any one of the aspects 1 to 5, the molded body may preferably have a thickness of less than 2.0 mm at a thinnest part.

In the electronic component of an aspect 7 of the disclosure in accordance with any one of the aspects 1 to 6, the molded body may preferably have a thickness of 0.5 mm or less at a thinnest part.

### Example

An example of the disclosure will be described below.

### [1] Preparation of Flame-Retardant Resin Composition

### [Sample 1]

First, Novaduran (registered trademark) (fiber-reinforced polybutylene terephthalate; PBT, GF30%; manufactured by Mitsubishi Engineering-Plastics Corp.) was dried with hot air at 120° C. for 8 hours as a resin material. After drying, for 100 parts by mass of the resin material, 12 parts by mass of brominated flame retardant Piroguard (Daiichi Kogyo Seiyaku Co., Ltd.) and 4 parts by mass of zirconium oxide (ZrO₂; product name: zirconium oxide, manufactured by Kojundo Chemical Lab. Co., Ltd.) were mixed and melt-kneaded using a vented twin-screw extruder with a screw diameter of 25 mm while drawing in a vacuum. Extrusion in the twin-screw extruder was carried out under conditions of a cylinder temperature of 250° C., a rotation speed of 120 rpm, and a discharge rate of 6 kg/h. A strand of the resin composition discharged from the die was passed through cooling water and cut to prepare pellets of the flame-retardant resin composition of Sample 1.

### [Sample 2]

Except for changing 4 parts by mass of zirconium oxide in the flame-retardant resin composition of Sample 1 to 4 parts by mass of hafnium oxide (HfO₂; product name: hafnium oxide, manufactured by Kojundo Chemical Lab. Co., Ltd.), pellets of the flame-retardant resin composition of Sample 2 were prepared under the same conditions as Sample 1.

### [Sample 3]

Except for changing 4 parts by mass of zirconium oxide in the flame-retardant resin composition of Sample 1 to 4 parts by mass of germanium oxide (GeO₂; product name: germanium oxide, manufactured by Kojundo Chemical Lab. Co., Ltd.), pellets of the flame-retardant resin composition of Sample 3 were prepared under the same conditions as Sample 1.

### [Sample 4]

Except for changing 4 parts by mass of zirconium oxide in the flame-retardant resin composition of Sample 1 to 4 parts by mass of tin oxide (SnO₂; product name: tin oxide (IV), manufactured by Hayashi Pure Chemical Ind., Ltd.), pellets of the flame-retardant resin composition of Sample 4 were prepared under the same conditions as Sample 1.

### [Sample 5]

Except for changing 4 parts by mass of zirconium oxide in the resin composition of Sample 1 to 4 parts by mass of antimony oxide (Sb₂O₃; product name: antimony oxide (III), manufactured by Kanto Chemical Co., Inc.), pellets of the flame-retardant resin composition of Sample 5 were prepared under the same conditions as Sample 1.

### [2] Preparation of Test Piece

From each of the flame-retardant resin composition pellets of Samples 1 to 5, a test piece (molded body) for flame-retardant evaluation was prepared. Using a molding machine with a mold clamping force of 40 tons, the pellets of the resin composition were heated and pressed at a heating temperature of 245° C. to mold a flat plate of approximately 89 mm×89 mm×0.4 mm thickness. This flat plate was cut in an arbitrary direction to prepare a test piece of 85 mm length×1.7 mm×0.4 mm thickness. Similarly, a test piece of 85 mm length×1.7 mm×0.8 mm thickness and a test piece of 85 mm length×1.7 mm×1.6 mm thickness were prepared from each of the pellets of the flame-retardant resin compositions of Samples 1 to 5.

Next, as a pretreatment, each test piece prepared was first placed in a constant temperature bath at 23±2° C. and 50±10% RH for 48 hours.

### [3] Evaluation of Flame Retardancy

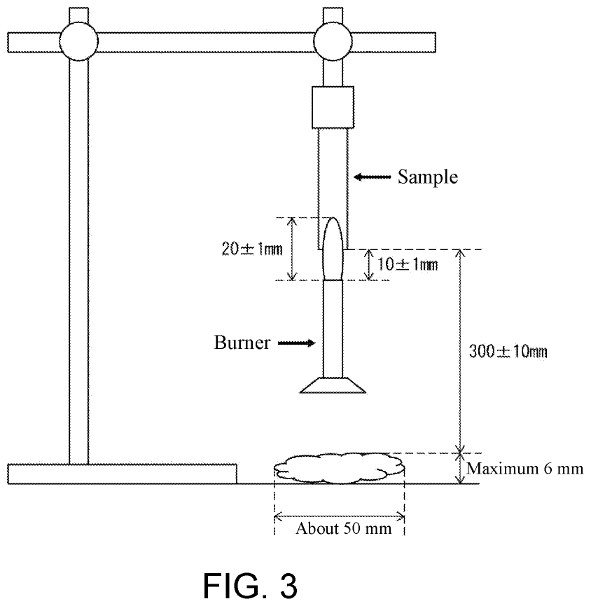

FIG. 3 is a schematic diagram for a flame retardancy evaluation apparatus in accordance with the UL94 flammability test standard. Using the flame retardancy evaluation apparatus shown in FIG. 3, flame retardancy was evaluated according to the UL94 flammability test standards. Specifically, the upper end of the prepared test piece (sample in FIG. 3) was clamped and the test piece was set vertically. A burner was used to apply flame to the lower end of the set test piece for 10±0.5 seconds. The afterflame time (t1) after the first flame separation was measured, and as soon as the flame was extinguished, the flame was again indirectly flamed for 10±0.5 seconds. The afterflame time (t2) and afterglow time (t3) after the second flame separation were measured. Next, Samples 1 to 5 were subjected to a UL94 combustion test according to the rank evaluation criteria shown in Table 1 below.

TABLE 1

| UL94 | | Flammability Classification | | |
|---|---|---|---|---|
| Rank Evaluation Criteria | | V-0 | V-1 | V-2 |
| (a) | Afterflame time of a test piece | 10 seconds or | 30 seconds or | 30 seconds or |
| | (t1) | less | less | less |
| (b) | Total burning time of five test | 50 seconds or | 250 seconds or | 250 seconds or |
| | pieces | less | less | less |
| (c) | Total of afterflame time and | 30 seconds or | 60 seconds or | 60 seconds or |
| | afterglow time of a test piece | less | less | less |
| | (t2 + t3) | | | |
| (d) | Burning to clamp | No | No | No |
| (e) | Eventual fire caused by | No | No | Yes |
| | dripping | | | |

As the results of the UL94 combustion test, those rated as V-2 or higher in Table 1 were evaluated as “∘,” and those that did not meet the V-2 criteria (that is, being V-1, V-0, and HB) were evaluated as “×.”

TABLE 2

Sample

| | | 1 | 2 | 3 | 4 | 5 |
|---|---|---|---|---|---|---|
| Inorganic Element | | Zr | Hf | Ge | Sn | Sb |
| Thickness | 1.6 mm | ∘ | ∘ | ∘ | ∘ | ∘ |
| of Molded | 0.8 mm | ∘ | ∘ | ∘ | ∘ | ∘ |
| Body | 0.4 mm | ∘ | ∘ | x | x | ∘ |

The molded bodies of the flame-retardant resin compositions of Samples 1 and 2 shown in Table 2 satisfied the evaluation criteria of V-2 or higher in Table 1 regardless of whether the molded body thickness is 0.4 mm, 0.8 mm, or 1.6 mm, and they exhibited the same level of flame retardancy as the molded body of the flame-retardant resin composition of Sample 5, which used antimony trioxide as the flame-retardant aid. It was confirmed that the molded bodies of the flame-retardant resin compositions of Samples 1 and 2 are useful as molded bodies of flame-retardant resin compositions containing no antimony trioxide.

Further, it was confirmed that the molded bodies of the flame-retardant resin compositions of Samples 1 and 2 do not contain antimony trioxide as the flame-retardant aid, and, as substitutes, have higher flame retardancy than the molded bodies of the resin compositions of Sample 3 containing germanium oxide and Sample 4 containing tin oxide.

As described above, the electronic component according to an embodiment may be used as electronic components such as relays such as micro relays, switches such as micro switches, and connectors, which are highly flame-retardant and highly safe against environmental pollution such as air pollution and water pollution.

What is claimed is:

1. An electronic component comprising:
a molded body molded from a flame-retardant resin composition containing a resin material, a brominated flame retardant, and an inorganic flame-retardant aid, wherein
the inorganic flame-retardant aid contains at least one element selected from Group IV elements.

2. The electronic component according to claim 1, further comprising:
an electrical contact, or the electrical contact and a coil, wherein
the molded body encloses the electrical contact and the coil or is in contact with the electrical contact or the coil.

3. The electronic component according to claim 1, wherein the molded body is at least one molded body selected from a base, a case, a card, a spool, and a housing.

4. The electronic component according to claim 1, wherein the electronic component is a relay, a switch, or a connector.

5. The electronic component according to claim 1, wherein the resin material is polyester-based resin.

6. The electronic component according to claim 1, wherein the molded body has a thickness of less than 2.0 mm at a thinnest part.

7. The electronic component according to claim 2, wherein the molded body has a thickness of less than 2.0 mm at a thinnest part.

8. The electronic component according to claim 3, wherein the molded body has a thickness of less than 2.0 mm at a thinnest part.

9. The electronic component according to claim 4, wherein the molded body has a thickness of less than 2.0 mm at a thinnest part.

10. The electronic component according to claim 5, wherein the molded body has a thickness of less than 2.0 mm at a thinnest part.

11. The electronic component according to claim 5, wherein the molded body has a thickness of 0.5 mm or less at a thinnest part.
